(19) United States
(12) Patent Application Publication
(10) Pub. No.: US 2011/0308829 A1
(43) Pub. Date: Dec. 22, 2011

(54) NAIL GUN

(75) Inventor: Xiaofei YANG, Qidong (CN)

(73) Assignee: Jiangsu Hehui Electronic Tools Co., Ltd., Qidong (CN)

(21) Appl. No.: 12/860,783

(22) Filed: Aug. 20, 2010

(30) Foreign Application Priority Data
Jun. 18, 2010 (CN) 2010203082.1

(51) Int. Cl. B25D 11/04

(52) U.S. Cl. 173/128

(57) ABSTRACT

A nail gun includes a motor and a driving mechanism that are optimally arranged to achieve continuous and efficient hammering within a compact structure. In one embodiment, the nail gun includes a chassis comprising a handle and a muzzle; a cylinder within an upper part of the chassis; a piston within the cylinder; an anvil within the muzzle; a motor within the handle; a rotation-linear motion conversion mechanism comprising a pendulum bearing for connecting the piston and the motor and converting a rotation of the motor into a linear motion of the piston; wherein the piston is configured to drive the air hammer to impact the nail continuously through the pin.

### CROSS-REFERENCE TO RELATED APPLICATIONS

This application claims priority under 35 USC §119 to Chinese Application No. CN2010203082.1, filed on Jun. 18, 2010, to inventor Xiaofei Yang, titled “Nail Gun,” the contents of which are incorporated herein by reference in their entirety.

### FIELD OF THE INVENTION

This disclosure generally relates to the field of electrically-driven tools, and, more particularly, to nail guns.

### BACKGROUND OF THE INVENTION

Nail guns are a common type of handheld tool, with many different varieties. Depending on the source of power, nail guns can be divided into two major categories: electrically-driven or pneumatic. Because pneumatic nail guns need a source of compressed air, their application is limited.

Electrically-driven nail guns have several different basic structures. In one type of electrically-driven nail gun, the rotation/linear motion conversion mechanism is a slide crank block mechanism, and the power supply is a battery. One problem with this type of electrically-driven nail gun is that the slide crank block structure does not in fact strike the nail like a hammer, but merely “pushes” the nail. As a result, it is not very efficient. A second problem with this type of nail gun is that the motor is located either in front of or behind the crank, and its conjunction with the crank block mechanism takes significant space, resulting in bulky nail guns that are not convenient to carry and operate.

In another type of electrically-driven nail gun, the rotation motion generated by the motor is first converted into a force that compresses a spring. Subsequently, the compressed spring is released by a release mechanism to strike the nail. Although this type of nail gun strikes the nail like a hammer through the compressed spring, it can only strike the nail once at a time, and cannot strike the nail continuously. As a result, it is also not efficient for extended use. In addition, the motor is located in the chassis under the gun muzzle, separate from the handle, resulting in a bulky structure.

There is also a type of nail gun that includes a compressed spring and an impact block to hammer the nail. It has a compact structure, and can be used to strike the nail continuously. However, it has a small impact force and only suitable for small nails iand consequently not suitable for hammering a wide variety of nails. Furthermore, the spring in this type of structure has a short life, and can easily become dysfunctional. The strikes produced by this type of nail gun lack uniformity, and the energy conversion rate is low. The battery is used up quickly, and the number of nails hammered per battery pack is low.

In light of the above problems, what is needed is a nail gun that can be used to strike nails continuously, has a big impact force, is efficient, compact, easy to carry and operate, and has a long life.

### SUMMARY OF THE INVENTION

In one embodiment, the nail gun includes a chassis and a motor. The main body of the chassis forms a vertical handle of the nail gun, an upper part of the chassis forms a horizontal muzzle of the nail gun; a cylinder is situated in the upper part of the chassis. The chassis includes a rotation/linear motion conversion mechanism; the motor is connected to a piston through the rotation/liner motion conversion mechanism. There is an anvil inside the muzzle of the gun for supporting and impacting a nail. The anvil is horizontally located inside cylinder through a sleeve. There is a piston inside the cylinder, and the piston contains an empty cylindrical chamber with one open end. An air hammer is installed inside the empty cylindrical chamber through a rubber sealing ring. The pin, the cylinder, and the air hammer are arranged to have a common axis. An opening inside the muzzle of the gun holds the nail and the opening and the anvil are arranged to have a common axis.

In one embodiment, the motor is installed vertically inside the main body of the chassis. The rotation/linear motion conversion mechanism includes a pair of bevel gears for reducing speed and changing orientation, one or more pendulum bearings, an intermediate shaft, and a bevel gear shaft. The pendulum bearing is coupled with the intermediate shaft, and connected to the piston through a hinge. The intermediate shaft is perpendicular to the bevel gear shaft. One bevel gear is coupled to the intermediate shaft, while the other bevel gear is coupled to the bevel gear shaft. The bevel gear shaft is connected to an output shaft of the motor through a flexible connection structure.

In accordance with embodiments of the present invention, the motor and the driving mechanism in the nail gun are optimally arranged to achieve continuous and efficient hammering within a compact structure.

### BRIEF DESCRIPTION OF THE DRAWINGS

FIG. 1 is a three-dimensional view of a nail gun in accordance with an embodiment of the invention.

FIG. 2 is a cross-sectional side view of a nail gun in accordance with an embodiment of the invention.

### DETAILED DESCRIPTION OF EXEMPLARY EMBODIMENTS

In the following description of exemplary embodiments, reference is made to the accompanying drawings which form a part hereof, and in which it is shown by way of illustration, specific exemplary embodiments in which the invention can be practiced. It is to be understood that other embodiments can be used and structural changes can be made without departing from the spirit and scope of the invention.

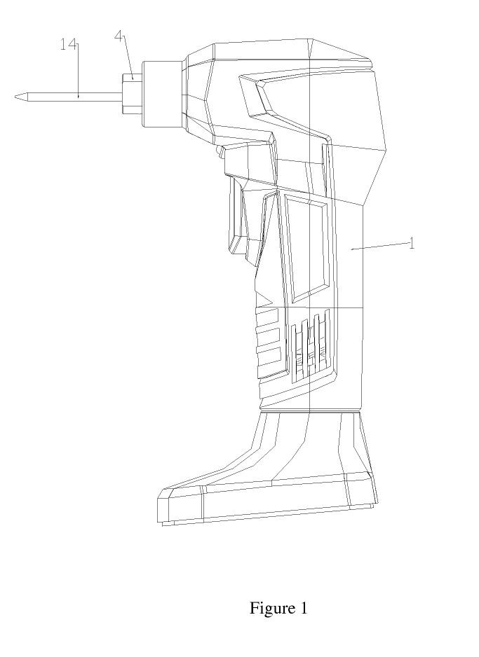

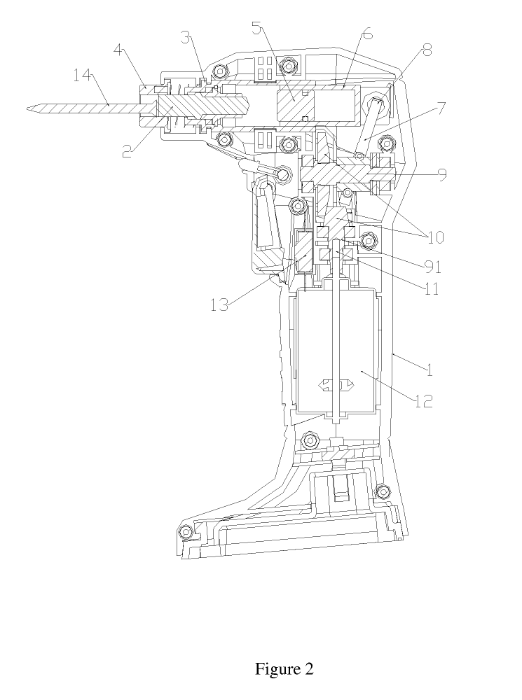

FIG. 1 is a three-dimensional view of a nail gun in accordance with an embodiment of the invention. FIG. 2 is a cross-sectional side view of a nail gun in accordance with an embodiment of the invention. As shown in FIGS. 1 and 2, the nail gun includes a chassis and a motor 12. The chassis is formed by a left half shell and a right half shell 1. The main body of the chassis forms a vertical handle of the nail gun, an upper part of the chassis forms a horizontal muzzle of the nail gun; a cylinder 3 is situated in the upper part of the chassis. The cylinder has one opening for letting air in, and two opening for letting air out. The chassis includes a rotation/linear motion conversion mechanism; the motor 12 is connected to a piston 6 through the rotation/liner motion conversion mechanism. There is an anvil 2 inside the muzzle of the gun for supporting and impacting a nail 14. The anvil 2 is horizontally located inside cylinder 3 through a sleeve. There is a piston 6 inside cylinder 3, and the piston 6 includes an empty cylindrical chamber with one open end. An air hammer 5 is installed inside the empty cylindrical chamber through a rubber sealing ring. The anvil 2, the cylinder 3, and the air hammer 5 are so arranged as to have a common axis. An opening 4 inside the muzzle of the gun holds the nail 14. The opening 4 and the anvil 2 are so arranged as to have a common axis.

In one embodiment, the motor 12 is installed vertically inside the main body of the chassis. The rotation/linear motion conversion mechanism includes a pair of bevel gears 10 for reducing speed and changing orientation, a pendulum bearings 7, an intermediate shaft 9, and a bevel gear shaft 91. The pendulum bearings 7 is coupled with the intermediate shaft 9, and connected to the piston 6 through a hinge 8. The intermediate shaft 9 is perpendicular to the bevel gear shaft 91. One bevel gear is coupled to the intermediate shaft 9, while the other bevel gear is coupled to the bevel gear shaft 91. The bevel gear shaft 91 is connected to an output shaft of the motor 12 through a flexible connection structure 11.

In one embodiment, an air spring can exist between one end of the air hammer 5 and the piston 6 for pushing the air hammer 5 along its axis toward the anvil 2. The nail gun may also include a battery pack for supplying power to the motor 12. However, this is not the only way for supplying power to the motor. In accordance with another embodiment of the present invention, power can be supplied to the motor through an AC power supply. Switch 13 is located on the chassis for starting and stopping the motor 12. The muzzle contains an anvil 2 for supporting and impacting nail 14. The anvil 2 is level or substantial level, and is located at the muzzle section of the cylinder 3 through a sleeve. The anvil 2 can move back and forth along with air hammer 5 through a vacuum created by the movement of the piston 6. During operation, one end of the anvil 2 strikes the head of the nail 14. Because the opening 4 at the muzzle is designed to be an indentation structures, the anvil 2 can fully impact the nail 14. The opening 4 is designed to have a diameter that is greater than the diameters of the most nails, so that nails of various sizes can be put into the opening 4. A portion of the anvil can be magnetized so that the nail may be attached to the anvil prior to being hammered, which further facilitates hand-held operation.

In accordance with one embodiment of the present invention, the rotation-linear motion conversion mechanism in the chassis converts the rotary motion of the motor 12 into a linear motion of the air hammer 5 to impact the anvil 2. The motor 12 is installed vertically in the chassis, and connected to the output shaft through a flexible connection structure 11. A pair of bevel gears is used to reduce speed and change orientation. The pendulum bearing 7 is coupled to the intermediate shaft 9, and connected to the piston 6 through a hinge connection. As a result, the pendulum moves back and forth. The air hammer 5 moves back and forth inside the piston 6 through the rubber sealing rings. When the air hammer 5 moves along with the piston 6 to a first position away from the nail, the anvil 2 moves toward the cylinder 3 due to the vacuum created by the piston 6, and air comes inside the cylinder 3 through the two ports, and the cylinder is in a state of storing energy. When the air hammer 5 is moved along with the piston 6 to a second position toward the nail, the air hammer 5 impacts the anvil 2, which in turn impacts the nail 14, the air spring between the piston 6 and air hammer 5 reduces the shocking effect of the impact, and air moves out of the cylinder 3. When the motor 12 keeps rotating, the air hammer 5 will keep impacting the anvil 2, which in turn impacts the nail 14.

Embodiments of the present invention have many advantages that prior art devices lack. First, after the rotary motion of the motor is converted to the linear motion of the pendulum bearing, the piston drives the air hammer moving back and forth, which enables the air hammer to impact the anvil directly. Because of the weight and considerable speed of the air hammer, the impact force is much greater than a “pushing” device. Continuous striking can be easily achieved through the use of the pendulum bearing.

Second, to improve performance, an air spring is situated between the air hammer 5 and the piston 6 such that when the piston 6 moves to a first position within the cylinder 3 away from the nail 14, the anvil 2 moves toward the inside of the cylinder 3 away from nail 14, while the air hammer 5 moves to the bottom of the cylinder 3 away from nail 14, and the air spring is in an energy-storing state. When the piston 6 moves to a second position within the cylinder 3 toward the nail 14, the air hammer 5 impacts the anvil 2, which then impacts the nail 14, thereby releasing energy and causing the air spring to be compressed. This ensures that during the normal operation of the motor, the air is promptly released from the cylinder through the ports, and that the anvil 2 impacts the nail 14 with sufficient force.

In short, in accordance with embodiments of the present invention, the nail gun includes a motor and a driving mechanism that are optimally arranged to achieve continuous and efficient hammering within a compact structure. In particular, the nail gun in accordance with the present invention can be easily handled by one hand, and is suitable for hand-held operation. In accordance with embodiments of the present invention, the nail gun can be used to continuously impact a nail, which solves the problem of not being able to punch in the nail through one strike associated with certain prior art nail guns. The direction of the gun handle and the direction of the nail hammering form a 90 degree angle, which enables the hammering of a nail in very narrow spaces. The air hammer in accordance with embodiments of the present invention generates a large impact force, and the nail gun can be used to handle a wide variety of nails.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

What is claimed is:

1. A nail gun, comprising:
a chassis comprising a handle and a muzzle;
a cylinder within an upper part of the chassis;
a piston within the cylinder;
a motor within the chassis; and
a rotation-linear motion conversion mechanism comprising a pendulum bearing for connecting the piston and the motor and converting a rotation of the motor into a linear motion of the piston, wherein the piston is configured to drive an anvil within the muzzle to impact a nail.

2. The nail gun of claim 1 wherein the nail gun is suitable for hand-held operation.

3. The nail gun of claim 2, wherein the nail gun is configured to impact the nail continuously.

4. The nail gun of claim 1, wherein the chassis is formed by a left half shell and a right half shell.

5. The nail gun of claim 1, further comprising an empty chamber with the piston, and an air hammer within the empty chamber.

6. The nail gun of claim 5, wherein the air hammer is installed in the empty chamber through a rubber sealing ring.

7. The nail gun of claim 6, further comprising a spring between the piston and the air hammer.

8. The nail gun of claim 7, wherein the pin, the cylinder, and the air hammer are so arranged as to have a common axis.

9. The nail gun of claim 8, wherein the cylinder comprises a first opening for letting air in and a second opening for letting air out.

10. The nail gun of claim 1, wherein the anvil is located inside the cylinder through a sleeve.

11. The nail gun of claim 1, wherein a portion of the anvil is magnetized.

12. The nail gun of claim 1, wherein the motor is located within the handle.

13. The nail gun of claim 1, wherein the rotation-linear motion conversion mechanism further comprises a first bevel gear coupled to an intermediate shaft, a second bevel gear coupled to a bevel gear shaft, wherein the intermediate shaft is perpendicular to the bevel gear shaft.

14. The nail gun of claim 13, wherein the pendulum bearing is coupled to the intermediate shaft, and the pendulum bearing is coupled to the piston through a hinge connection

15. The nail gun of claim 14, wherein the bevel gear shaft is coupled to an output shaft of the motor through a flexible connection structure.

16. The nail gun of claim 1, wherein the nozzle comprise an indented opening for holding the nail.

17. The nail gun of claim 1, further comprising a battery pack within the chassis.

18. A hand-held nail gun, comprising:
a chassis comprising a handle and a cylinder;
an impact member within the cylinder;
a motor within the handle; and
a rotation-linear motion conversion mechanism comprising a pendulum bearing for coupling the impact member and the motor and converting a rotation of the motor into a linear motion of the impact member, wherein the impact member is configured to repeatedly impact a nail.

19. The nail gun of claim 18, wherein the rotation-linear motion conversion mechanism further comprises a first bevel gear coupled to an intermediate shaft, a second bevel gear coupled to a bevel gear shaft, wherein the intermediate shaft is perpendicular to the bevel gear shaft.

20. The nail gun of claim 18 wherein the impact member comprises a piston having a cylindrical chamber, an air hammer located within the cylindrical chamber of the piston and an anvil configured to be driven by the air hammer to impact the nail.
